(19) United States
(12) Patent Application Publication
(10) Pub. No.: US 2010/0038373 A1
(43) Pub. Date: Feb. 18, 2010

(54) AUTOMATED FOOD SERVICE SYSTEM FOR REMOTE RECREATIONAL FACILITIES

(76) Inventor: Frank Ottomanelli, Maspeth, NY (US)

Correspondence Address: DUANE MORRIS LLP - NY;PATENT DEPARTMENT, 1540 BROADWAY, NEW YORK, NY, 10036-4086, US

(21) Appl. No.: 12/582,059

(22) Filed: Oct. 20, 2009

Related U.S. Application Data
(63) Continuation of application No. 29/317,618, filed on May 2, 2008, now Pat. No. D602531.
Application No. 29/317,618 is a continuation-in-part of application No. 11/132,238, filed on May 19, 2005, now abandoned.
(60) Provisional application No. 60/572,100, filed on May 19, 2004.

(51) Int. Cl. G07F 11/00; A47F 3/04

(52) U.S. Cl. 221/2; 221/135

(57) ABSTRACT

A system is described with allows the delivery of butcher shop meat services to a remote location, such as marinas, campsites, parks etc., without significant input required from on site management personnel. Management operations are performed from a remote location. This includes food item selection, preliminary preparation, monitoring of inventories (and re-supply when necessary) and payments. By using this system, managers of remote locations can significantly enhance the ability to meet customer's needs without having to hire or train butcher shop personnel to manage each site.

This application claims benefit of U.S. Provisional Application No. 60/572,100, filed May 19, 2004.

### BACKGROUND OF THE INVENTION

Outdoor camping, picnicking etc. are common leisure pastimes. Frequently associated with such occasions is outdoor cooking on a charcoal or gas grill a smoker or other outdoor cooking apparatus. Traditional grilled foods include hamburgers, steaks, sausages etc. For cooking on a patio or in a backyard, the food is readily available. However, outdoor cooking is also performed at remote locations having no access to household refrigerators and conveniences. At these locations, supplying food can be an important and limiting consideration.

At outdoor cooking locations, usually the only locally available food, if any, is typically soft drinks, candy bars and other snack foods. Accordingly, travelers away from home must bring their own food for cooking. This practice has several disadvantages. The amount of food is substantially limited by the size of the food container, usually a cooler or ice chest. Container capacity is further limited by the presence of various means of keeping the content frozen; ice, dry ice, cool packs etc. Moreover, the frozen food begins to thaw almost immediately and is preserved for only about a single day. When the content of a cooler approaches room temperature, the consumer will face an uncertain deadline after which food is no longer safe to consume. Being highly adverse to the risk of food poisoning, a consumer will often discard food of questionable freshness even though the consumer cannot be sure that the food had actually gone bad.

### OBJECTS OF THE INVENTION

It is a general object of the invention to relieve the traveler of concerns about packing and preserving food for use in outdoor cooking.

Another general object of the invention is to provide a food service at a remote site that requires little or no effort on behalf of a remote site manager.

A further object of the invention is to effectively provide butcher shop service at remote locations.

Another object of the invention is to provide the remote service continuously; round-the-clock, seven-days-a-week.

A further object is to provide automated or self service butcher shop service where food products are dispensed and paid for without direct input from a butcher shop proprietor.

A still further object of the invention is to provide for efficient management of a remote butcher shop where inventories are automatically recorded and the operational conditions of machinery are automatically measured and recorded.

Still another object of the invention is to provide for remote management requiring little or no specific effort from the local site manager.

Another object of the invention to efficiently control a plurality of remote butcher shop service locations.

### BRIEF SUMMARY OF THE INVENTION

An embodiment of the present invention that is intended to accomplish at least some of the foregoing objects comprises a system for dispensing fresh and frozen food to consumers at remote locations. Remote locations include marinas, campgrounds, urban parks and other locations. The system also includes small environmentally friendly self-service automated retail shops that will provide round-the-clock service, seven days-a-week. The shop can be configured to accept both cash and cashless payment, provide computerized transaction records and 24/7 telemetry to monitor performance, facilitate and accelerate stock replenishment and maintenance by allowing remote access to the telemetry. In a preferred embodiment, delivery and maintenance personnel can access the information, with a handheld device, either directly from the machine or indirectly from off site locations such as an internet web page.

### BRIEF DESCRIPTION OF THE DRAWINGS

FIG. 1 illustrates a front view of an automatic butcher shop showing a typical selection of butcher shop food available for campground consumers.

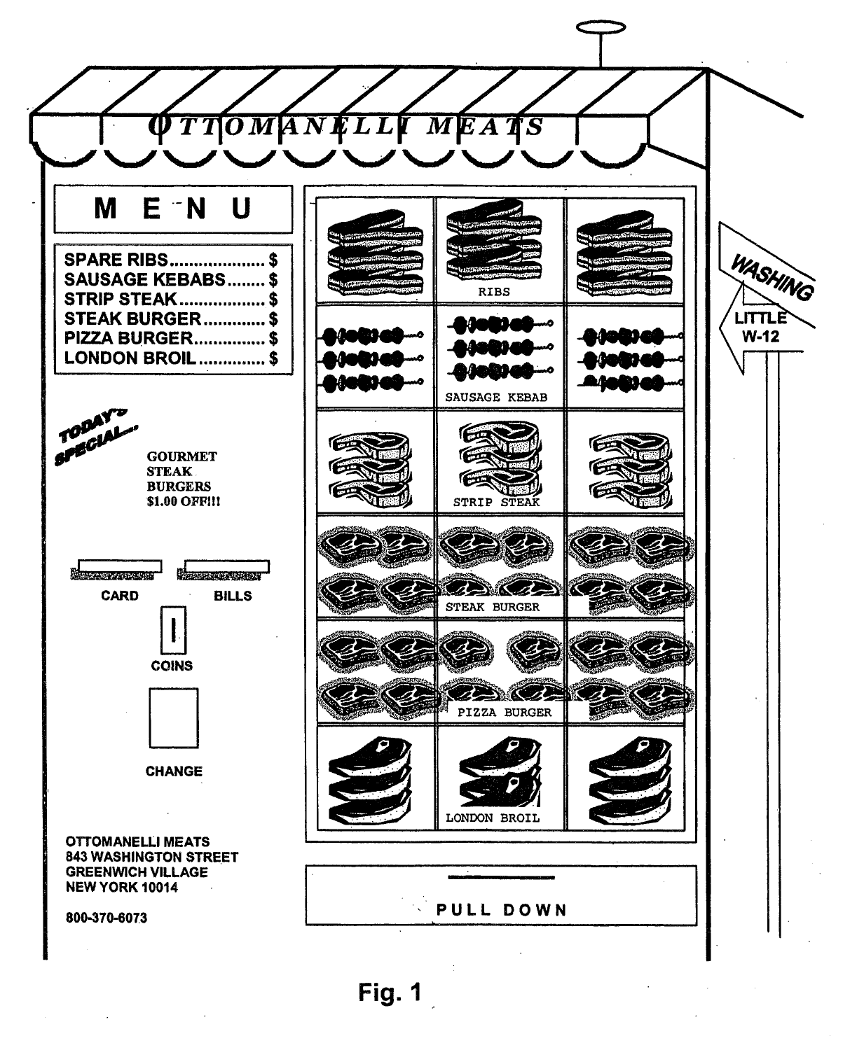

### DETAILED DESCRIPTION OF THE INVENTION

Managers of remote facilities seek to satisfy their customers with a clean, well run facility. By using the disclosed invention, these managers can provide an added value for their customers—for example, immediate on-site access to butcher shop services. More specifically, managers can provide a substantial selection of fresh and frozen food butcher shop items for outdoor cooking.

Ordinarily, it would be impractical for a marina or campground manager to supply butcher shop items. Substantial time commitments and experience are required to safely and profitably operate a butcher shop. One must deal knowledgeably with meat wholesalers and meat inspectors. Furthermore, one must know how to properly butcher sides of beef, know a myriad of public health and safety regulations and storage requirements to maintain meat in a safe and attractive display.

Finally, and perhaps most importantly, one must have a feel for what types of food items are popular with consumers. Stocking the correct items is critical for success of the operation which is dependent upon generating a reasonably large sales volume.

Surprisingly, the inventor has designed a practical system by which a remote site manager without any special knowledge in this field, can offer butcher shop services. As a result, a local manager can offer butcher shop retail services merely by supplying a 12 Amp, 110-volt electrical outlet.

Furthermore, the local manager will profit as a result of this service, either by receiving rental payments for the space allocated for the service or by receiving commissions based on the sales transactions. The manager will also profit in indirect ways. For example, a campground manager will provide an enhanced camping experience which will attract more campers, encourage campers to say on the campgrounds longer and return more often.

Remote locations will be provided with an automated dispensing apparatus stocked with carefully selected butcher shop food items. Based on experience, each of the following selections are functional in the disclosed system. In order to be functional, each of the following foods must have physical properties such that they can be preserved for a sufficient time at the remote location and, after outdoor cooking, will suffer no significant losses in flavor.

The specific method of cooking is also taken into account. The following foods are selected for compatibility with the specific types of outdoor cooking apparatus traditionally utilized: grills, gas grills, charcoal grills, hickory cooking, mesquite cooking, use of smokers, etc. In addition to the physical properties, these foods must have another property in order for the system to function optimally. Each of these food items are believed to be popular with the consumer found at the remote locations so that a sufficiently high sales volume can be established.

Some examples of the foods to be stocked are: ribs; marinated ribs; meat kebabs (chicken, beef, lamb, pork, etc); blackened chicken; chicken breasts; boneless strip steaks; filet mignon steaks, teriyaki steaks, hamburger, hamburger patties; pork chops, stuffed pork chops, beef London broil, Delmonico steaks, sirloin steak, Italian sausage, chicken cutlets, fish, and pork loin. On the other hand, some food items, while popular, are not practical for all but a few specific embodiments of this system; live Main lobsters, for example.

Some further specific examples of food items to be provided are: “country style” ribs marinated in barbecue sauce; precooked barbecue ribs; lemon/pepper chicken cutlets, cranberry stuffed chicken breast, gourmet steak burgers 90% lean, poached salmon in sweet red pepper sauce, and pork loin with apple sauce or apple cider sauce. It is also specifically contemplated to offer “all natural” or “organic” versions of the above food items.

Rather then building a permanent structure to house a retail shop, a portable structure will be utilized in accordance with a preferred embodiment of the invention. The various butcher shop items will be stored in an enclosed climate controlled structure. Specifically, the structure will be capable of refrigerating the items or freezing the items. Standard temperatures for refrigeration and freezing of butcher shop items can be used. The temperatures and atmospheric conditions inside the structure will be such that the food is preserved for the longest possible time without significantly effecting food quality.

In one preferred embodiment, humidity levels will be maintained such that the food will not undergo freezer burn. Alternatively, “frost free” freezing conditions can be used so long as steps are taken so that food items are rendered resistant to freezer burn. For example, the food items can be stored in individual compartments within the overall structure so that they will be substantially resistant to freezer burn. In another preferred embodiment, the food can be wrapper or otherwise packaged so as to be resistant to freezer burn. Any method of hermetically sealing the food can be used, for example vacuum sealing individual food items. Alternatively, the food stocks can be rotated or otherwise monitored so that the food does not remain under “frost free” conditions long enough for significant freezer burn to develop.

Preferably, stocking of the retail outlets will be accomplished by outside contractors. These contractors will monitor inventories by methods set forth below. When the stocks are depleted, the contractors will travel to the remote locations and restock the local retail shops. In one embodiment, the stocks are delivered to each individual retail shop from a central food warehouse. In another embodiment, a plurality of regional warehouses is used. Each regional warehouse is placed in a location convenient to service the retail shops in that region. Convenient regional warehouse locations can be, but need not be, a location central to that region's retail shops. Alternatively, the regional warehouse can be located close to a transportation hub; an airport, a common carrier pickup center, etc.

Regional warehouses are also contemplated when special needs arise, for example a group of retail shops that are close together but far from the central warehouse can be efficiently served from a regional warehouse. Also, retail shops with a high sales volume can be serviced from appropriately designed regional warehouses with extra storage space and delivery trucks to meet the high demand.

Another special design is to offer kosher food items. Sources of the ingredients are chosen and the status of all of the production, maintenance, delivery and storage equipment is monitored and controlled so as to ensure kosher certification from the appropriate authority.

Another preferred embodiment includes devices that can monitor the inventory automatically and report this data automatically. The inventory data can be obtained by a visit to the local retail site. Any manual or automatic method of reading data can be used in the invention. The inventory data can be read directly from a display on the structure and recorded on a clipboard. Alternatively, data can be read automatically by a hand held device, or laptop computer, then up loaded to a suitable database. An example of a suitable database would be a file server that can be accessed via an internet connection.

Still another suitable mode of data collection is to equip the local retail shop with a device capable of transmitting the data to a remote location without the need for a visit to the remote location. For example, inventory data can be sent by an internet connection to a site on the internet. In effect, the remote shop will automatically report its current inventory to the internet site. Thus, the supplier can stock his truck appropriately by monitoring the internet site without first having to visit the remote shop.

Food items will be displayed and dispensed to consumers in a similar manner to standard vending machines. Typically, the food is displayed with the use of transparent doors so that the consumer can see the food prior to making a purchasing decision. The price for each food item is displayed next to the food item. After the consumer tenders the appropriate payment, the food item is made accessible to the consumer using any of the myriad devices developed for use with vending machines.

In addition to displaying the food items, messages can also be displayed to encourage sales. In one embodiment, an electronic blackboard is provided which is capable of displaying one or more messages depending on the time of day, the season of the year or other conditions. For example, sales or “specials of the day” can be displayed.

Any reliable payment system can be used in connection with the above disclosed system. Either cash or cashless payments are specifically contemplated. The remote location can be equipped with a device that enables automatic cash purchases, such as a currency reader. Specific cashless payment devices contemplated include payments via: credit card, debit card, ATM card, various prepaid debit cards, etc. In the later cases, the remote location can include a card reader. The cash-less payment modes are particularly convenient in view of the price of the various goods being offered which will be in the price range typically paid by consumers with credit cards and other cash-less payment cards.

Upon occasion, an operator may issue discount coupons, for example during a promotional event. The payment system can be configured to recognize discount coupons. The payment system can be configured to accept the coupon in the same manner that cash is accepted. The system will then read the coupons and deduct the appropriate amount from the food price.

A coupon can have a permanent denomination chosen when the coupon is printed. Alternatively, a value can be assigned to a coupon at a later time. For example, a coupon can be imprinted with a unique machine readable code. The payment system operator then programs a cash credit to be associated with that unique code. When the coupon is presented to the payment system, the credit is deducted from the purchase price.

Cash can be collected from the structure using any standard procedure. Cash can be collected by the same contractor hired to perform other services, such as restocking. Alternatively, a special contractor can be hired to perform cash pickups, for example an armored car carrier. The later embodiment, while more costly, is preferable in instances where a large amount of money is to be collected or when making collections in high crime areas.

The results of these various payment transactions can be monitored and reported in a manner similar to that of the inventory reporting. Telemetry can be obtained either manually or automatically, and can be gathered by visiting to the remote site or by transmittal from the remote site to a database.

In addition to stocking and payment systems, the invention also includes a maintenance system. The various devices at the remote location can be monitored by personal inspection. However, a preferred embodiment comprises a system of automatic monitoring. The status and performance can be manually or automatically monitored and recorded, as described above for other systems.

Telemetry sent from the remote location can be monitored on a round-the-clock basis. As a consequence, a breakdown will be immediately detected and addressed with an appropriate response, even if the breakdown occurs after normal working hours. The breakdowns can be the result of numerous causes; including device malfunction, power failure, vandalism and other causes.

In a preferred embodiment, a contractor is hired to service the machine. This contractor can be the same one used to provide other services, such as restocking. Alternatively, a special contractor can be used to service the machines. In still another embodiment, routine service can be provided by one contractor but more serious breakdowns are handled by specialized contractors.

With respect to the locations of the remote food service, any location away from the consumer's home refrigerator is specifically contemplated. Examples include: campgrounds (private, state and federal), marinas, parks, urban parks, state parks, national parks, picnic areas, sporting grounds, parking lots of sports stadiums, sites for tailgate parties, etc.

### SUMMARY OF MAJOR ADVANTAGES OF THE INVENTION

The remote location of the disclosed food service relieves the traveler of concerns about packing and preserving food for use in outdoor cooking.

The fully automatic features, including automated sale of the butcher shop food items as well and the off site servicing of the disclosed food service relieve the remote site manager of any significant duties toward managing the food service.

The categories of food items offered for sale at the remote location will include a significant portion of those food items offered at butcher shops thus providing butcher shop services at a remote location.

The subject retail shops allow the service to be offered on a round-the-clock basis.

The automation features also allow a butcher shop to offer its services at remote locations without having to hire on site staff to collect payment and dispense the food item to the customer.

The automation and data systems allow efficient management of the remote butcher shop through off site monitoring of the status of the remote butcher shop.

Furthermore, the data systems with their automatic recording systems will free the remote site manager from the need to report on the status of the remote butcher shop.

Systems that communicate data from the remote site to offsite locations allow for the efficient management of a plurality of remote butcher shops. The plurality of shops are configured to report to managers at a relatively few offsite locations or even to a single manager at a single offsite location.

What is claimed is:

1. A dispensing system for delivery of butcher shop meat items to a customer comprising:
a portable structure configured to maintain environmental conditions suitable for maintaining butcher shop meat items in a maintenance condition
a selected set of butcher shop meat items positioned within said portable structure,
a dispensing system configured for dispensing of said butcher shop meat items wherein said dispensing system requires a customer to provide payment before said butcher shop meat items are dispensed,
whereby said butcher shop services are dispensed to customers without monitoring by the presence of local personnel.

2. A dispensing system for delivering of butcher shop meat to a customer as defined in claim 1 and further comprising:
a system connected to said portable structure for remote managing of said payments,

3. A dispensing system for delivering of butcher shop meat to a customer as defined in claim 1 and further comprising:
a system connected to said portable structure for remote managing of meat items inventory.
